(19) United States
(12) Patent Application Publication
(10) Pub. No.: US 2024/0033957 A1
(43) Pub. Date: Feb. 1, 2024

(54) NOSE HAIR CUTTER

(71) Applicant: Terry & Scott Unternehmergesellschaft (Haftungsbeschraenkt), Guetersloh (DE)

(72) Inventor: Alexander Weese, Guetersloh (DE)

(21) Appl. No.: 18/258,350

(22) PCT Filed: Dec. 21, 2021
(86) PCT No.: PCT/EP2021/087171

§ 371 Date: Jun. 20, 2023

(30) Foreign Application Priority Data
Dec. 22, 2020 (DE) 20 2020 005 266 U

(51) Int. Cl. B26B 19/14; B26B 19/38

(52) U.S. Cl. CPC B26B 19/148; B26B 19/3846

(57) ABSTRACT

A nose hair cutter for cutting nose hairs includes a main part formed along an axis of the main part including a cutting head and a handle connected thereto on a first end of the main part. A blade is arranged on the cutting head including a cutting edge extending in an axial direction. The blade is arranged on the cutting head such that the cutting edge of the blade protrudes at least in portions from a surface of the cutting head extending in a peripheral direction, such that the cutting edge intersects the hairs supplied thereto on an exterior of the cutting head. The cutting edge extends in a first plane of the main part extending in a radial direction. A flat facing the axis is positioned at least in portions at an acute angle of attack relative to the first plane.

### CROSS REFERENCE TO RELATED APPLICATIONS

This application is a U.S. National Phase application under 35 U.S.C. § 371 of International Application No. PCT/EP2021/087171, filed on Dec. 21, 2021, and claims benefit to German Patent Application No. DE 20 2020 005 266 U, filed on Dec. 22, 2020. The International Application was published in German on Jun. 30, 2022 as WO 2022/136483 A1 under PCT Article 21(2).

### FIELD

The invention relates to a nose hair cutter having a cutting head and a handle, for cutting nose hairs.

### BACKGROUND

Nose hairs projecting from the nose are frequently perceived as unaesthetic, especially in the case of intense nose hair growth, leading to a cosmetic motivation for shortening the nose hair.

There is no medical indication for shortening nose hairs, since nose hairs filter out coarse components from the air and thus protect the airways. It may not therefore be recommended to completely remove the nose hairs, as can be done, for example, by corresponding laser radiation.

Shortening nose hairs is basically medically harmless, and various methods are known for this. One of these methods is what is known as plucking, in which the nose hairs are torn out of the skin by means of tweezers, for example. However, this method may not be recommended, since health problems can also arise in addition to the pain immediately caused. This method can therefore be associated with the formation of inflammation or furuncles.

Due to the forcible removal of the nose hairs, lesions can arise, through which bacteria pass into the bloodstream and lead to further health impairments. Similar applies to nose hair removal with wax.

Furthermore, the flaming of nose hairs is known, which, however, due to the increased risk of injury, for example with regard to burns or damage to the nasal mucosa, may not be a reliable form of shortening nose hair, in particular when this is done without trained specialist personnel or by amateurs.

For gently shortening nose hairs, nose hair cutters of the type in question are used, with which, for example, the hair located at the nose inlet or in the nasal vestibule can be cut as gently as possible without causing skin irritation or inflammation. They are known in various embodiments and are also referred to inter alia as nose hair trimmers.

Nose hair cutters of the type in question can initially be distinguished into those having a rotating blade and those having a fixed blade the cutting head or main part.

Furthermore, a distinction can be made between nose hair cutters with and without their own drive for a movement of the blade.

In the case of nose hair cutters having their own drive, the function is dependent on an energy source which can be formed, for example, by a battery. Nose hair cutters without their own drive have the advantage that they can be used independently of an energy source and thus by a hand movement for cutting nose hairs.

Nose hair cutters are also suitable for removing the hair located on the outer ear canal, such that its use is not necessarily limited to the nose.

Usually, nose hair cutters of the type in question are equipped with a main part formed along an axis of the main part, in order to make the design as compact as possible and to simplify handling when used.

The main part may have a cutting head on an end of the main part, which cutting head is configured and designed to cut the nose hairs. Furthermore, the main part has a handle which is connected to the cutting head and which extends from the cutting head in the direction of a second end of the main part. The handle serves for the simple movement of the cutting head, for example to also facilitate insertion into the nostril and an alignment, in addition to cutting.

For cutting the nose hairs, a blade having a cutting edge extending in the axial direction to the axis of the main part for cutting the nose hairs is arranged on the cutting head, thereby promoting a compact design.

In addition to the above-mentioned problems, the known nose hair cutters may have, inter alia, the problem that shortening of the nose hairs lacks the desired cutting success and is time-consuming, since several cutting processes are frequently necessary in order to achieve the desired shortening of the nose hairs.

### SUMMARY

In an embodiment, the present disclosure provides a nose hair cutter for cutting nose hairs, including a main part formed along an axis thereof. The main part includes a cutting head and a handle connected thereto on a first end of the main part. A blade is arranged on the cutting head including a cutting edge extending in an axial direction to the axis of the main part for cutting the nose hairs. The blade is arranged on the cutting head such that the cutting edge of the blade protrudes at least in portions from a surface of the cutting head extending in a peripheral direction to the axis of the main part, such that the cutting edge intersects the nose hairs supplied to the cutting edge on an exterior of the cutting head. The cutting edge extends in a first plane of the main part extending in a radial direction to the axis of the main part. A flat facing the axis of the main part is positioned at least in portions at an acute angle of attack relative to the first plane of the main part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of a nose hair cutter according to an embodiment of the present invention, in a vertical orientation;

FIG. 2 shows the embodiment of a nose hair cutter according to the present invention in a view rotated by 90° about the axis of the main part, relative to the illustration in FIG. 1, the representation being concentrated on the cutting head;

FIG. 3 shows the embodiment of a nose hair cutter according to the present invention in a schematic view, indicated by A in FIG. 2, concentrated on the blade arrangement;

FIG. 4 shows the embodiment of a nose hair cutter according to the present invention in a handling position in the same view as in FIG. 1;

FIG. 5 shows the embodiment of a nose hair cutter according to the present invention in an identical representation as in FIG. 2, but in a schematic longitudinal sectional view along the first plane of the main part, rotated by 90° about the axis of the main part;

FIG. 6 shows the embodiment of a nose hair cutter according to the present invention in the same view as one in FIG. 1, the main parts being in a pre-assembly state in which they are unconnected from one another; and

FIG. 7 shows a blade of the embodiment of a nose hair cutter according to the present invention in a view identical to FIG. 2, the view being concentrated on the blade.

### DETAILED DESCRIPTION

Embodiments of the present invention provide a nose hair cutter which enables efficient cutting of nose hairs and is also safe in handling.

Embodiments of the present invention are based on the idea of changing the blade design compared to the known embodiments.

Furthermore, embodiments of the present invention break away from the idea of using a quickly rotating cutting head in order to achieve a correspondingly better cutting result. In this context, it has been found that, in the case of a cutting head having a rotating blunt blade, the nose hair is torn out of the skin and causes the problems known from plucking.

Similar applies for scraping off nose hairs at the skin surface, from which embodiments of the present invention also turn away.

Furthermore, embodiments of the present invention move away from the use of aids such as a glow wire for shortening the nose hairs. Likewise, embodiments of the present invention break away from the approach of heating the blade or edge by a heat source in order to positively influence the cutting result.

Rather, embodiments of the present invention utilize a surprisingly effective approach, by improving the cutting performance in the case of a nose hair cutter formed according to an embodiment of the present invention, by a clever arrangement and orientation of the blade on the cutting head, so that during a cutting operation a plurality of nose hairs are cut at the same time and safely.

Embodiments of the present invention thus make it possible to increase the effectiveness of cutting of nose hairs, as a result of which the cutting process can also take place in a short time and is thus efficient, by means of a nose hair cutter according to an embodiment of the present invention.

For this purpose, embodiments of the present invention provide that the cutting edge of the blade projects at least in portions from a surface of the cutting head extending in a peripheral direction to the axis of the main part, in such a way that the cutting edge intersects the nose hairs fed to it on an exterior of the cutting head.

Within the context of embodiments of the present invention, a surface is understood to be the outwardly facing lateral surface or outer surface which faces away from the axis of the main part, from which the cutting edge exits at least in portions to the outside and protrudes for contact with the nose hair.

Furthermore, it is provided according to embodiments of the present invention that the cutting edge extends in a first main part plane extending in the radial direction relative to the axis of the main part, and a flat facing the axis of the main part is positioned at least in portions at an acute angle of attack relative to the first main part plane.

The acute angle of attack of the blade relative to the first main part plane, according to embodiments of the present invention, leads to the advantage that a deformation of the edge of the blade during the cutting of the hair can be kept low or can be prevented, since its deformation resistance is improved with respect to a blade extending in the radial direction relative to the axis of the main part. Embodiments of the present invention thus allow the use of thin blades having a thickness of less than 1 mm, which can be designed, for example, and in particular in the manner of a shaving blade.

A cutting edge extending in the axial direction of the axis of the main part brings about a design of a wide cutting region on the cutting head, so that a plurality of nose hairs can be simultaneously cut by the blade and thus shortened, by means of a blade arranged on the cutting head.

Furthermore, the arrangement of the edge on the exterior of the cutting head makes it possible to shorten the nose hairs close to the skin surface on which the respective hair projects. Embodiments of the present invention thus allow the period until the next shortening of the nose hairs to be extended, as a result of which the nose hair cutting has a more lasting effect.

Finally, as a result of an orientation of the flat that is inclined according to embodiments of the present invention, the edge emerges, in the cutting region of its cutting head, in a manner having its cutting edge inclined relative to the surface of the cutting head, which extends in the peripheral direction about the axis of the main part. The edge thus strikes the nose hairs fed, to it over the surface of the cutting head, at an acute angle of inclination.

It has surprisingly been found that an efficient cutting of the nose hairs is achieved by the arrangement according to embodiments of the present invention of the blade on the cutting head. As a result, a repeated cutting operation is not necessary for shortening the nose hairs, as a result of which a risk of injury is also minimal. In addition, tearing out the nose hairs during the cutting process is thus avoided.

Within the context of embodiments of the present invention, it has been shown that an angle of attack between 25° and 75° brings about a good cutting performance. The cutting performance can be increased in particular by the angle of attack having a value between 30° and 60°. It has also been shown that the cutting performance is particularly increased if the angle of attack has a value between 44° and 46°. In the context of embodiments of the present invention, an optimal cutting performance was found if the angle of attack has a value of 45°. Therefore, the aforementioned angles of attack are taken into account in a further advantageous development of an embodiment of the present invention.

Within the context of embodiments of the present invention, it has been shown that the orientation of the blade provided according to embodiments of the present invention results in improved cutting of the nose hairs compared to such blades of which the cutting edge is oriented in parallel with the axis of the main part, and the flat of which extends in the radial direction relative to the axis of the main part.

Against this background, an advantageous development of embodiments of the present invention provides that the cutting edge of the blade to the axis of the main part is inclined at an acute angle of inclination in the direction of the first main part end of the main part. This reduces the radial distance of the cutting blade from the axis of the main part, in the direction of the first body end of the main body, thereby enabling a compact design of the cutting head.

Within the context of embodiments of the present invention it has proven advantageous that the arrangement according to embodiments of the present invention of the blade at an acute angle of inclination relative to the axis of the main part supports a simple introduction of the nose hair cutter into a nasal cavity. Furthermore, it has been found that the cutting of the nose hairs leads to a better result due to the arrangement according to embodiments of the present invention of the blade on the cutting head.

In a further advantageous development of an embodiment of the present invention, it is provided that the angle of inclination has a value between 5° and 20°, in particular between 5° and 15°, preferably between 8° and 12°, most preferably a value of 10°.

Within the context of embodiments of the present invention it has been found that the cutting performance can be increased by corresponding inclination of the cutting edge relative to the axis of the main part according to the aforementioned values. It is equally possible to design the cutting head according to the inclination of the cutting edge, in order to thereby also achieve improved handling of the nose hair cutter for cutting the nose hairs, in a compact design.

It has been found that, by means of an arrangement according to embodiments of the present invention, the cutting head of the nose hair cutter, the nose hairs can be cut safely and also at a sufficient depth in the nasal cavity, so that a nose hair cutter designed according to embodiments of the present invention implements an efficient handling for the shortening or cutting of nose hairs.

For easy handling of a nose hair cutter formed according to embodiments of the present invention, the handle can be designed in various ways and connected to the cutting head.

Within the context of embodiments of the present invention, it is provided, for example and in particular, that the handle is formed along the common axis of the main part, with the cutting head, in the manner of a stem, so that the handle enables a very compact design of a nose hair cutter according to embodiments of the present invention and also achieves simple handling.

The cutting of nose hairs by means of a nose hair cutter according to embodiments of the present invention is based on a relative movement between the nose hair and the blade so that, when there is contact between the nose hair and the cutting edge, the blade cuts the nose hair by the relative movement with respect to the latter. In order to generate a relative movement between the nose hair and blade, various possibilities for generating movement can be used according to embodiments of the present invention.

In order to promote simple handling, it is provided within the context of embodiments of the present invention that a rotational movement or a torque can be applied to the cutting head via the handle, as a result of which the cutting head rotates about the axis of the main part during cutting and thus effects the relative movement between the blade or its cutting edge and the nose hair.

In this case, the nose hair, which is guided on the surface of the cutting head, is fed to the cutting edge of the blade, and is brought into contact for cutting.

Accordingly, embodiments of the present invention are based on the need for a separate drive for the blade movement relative to the nose hair. A motor drive is thus saved, which in turn requires an energy source, for example a battery, for its operation.

According to embodiments of the present invention, a hand movement produce a relative movement of the cutting edge relative to the nose hair that is important for the cutting process. In this context, it has been found that the handle can be held very easily between the thumb and forefinger or middle finger. In this case, a relative movement between thumb and forefinger or middle finger can cause a rotational movement of the cutting head. Alternatively, the relative movement can also be generated by a rotational movement of the hand.

Within the context of embodiments of the present invention, a rotational movement of the cutting head or the blade is also understood to mean a rotational movement of less than 360°. Within the context of embodiments of the present invention, it has been found that a rotational movement far below 180°, preferably even up to 120°, is already sufficient in order to cut the nose hairs.

Against this background, it is provided in a further advantageous development of embodiments of the present invention that the cutting head and the handle are connected to one another for a transmission of rotational movement between them. Therefore, the handle is designed and configured, for example and in particular, as a turning handle for the cutting head. Accordingly, a torque can be transmitted from the handle to the cutting head.

In order to prevent cutting injuries during cutting of nose hairs, it is provided in a further advantageous development of embodiments of the present invention that at least one first, in particular groove-shaped, guide groove for the nose hair, which extends in a peripheral direction to the axis of the main part, is formed on the surface of the cutting head, into which guide groove the blade projects at least in portions with an edge that forms the cutting edge.

Thus, the guide groove or its profile in the peripheral direction is arranged transversely to the cutting edge or an edge of the blade forming the cutting edge.

In the context of embodiments of the present invention, the at least one guide groove can, for example, extend longitudinally around the cutting head, and in particular partially peripherally.

The guide groove according to embodiments of the present invention advantageously results in it being possible for the nose hairs to be fed to the cutting edge in a bundled manner. Furthermore, the use of such a guide groove is to enable safe cutting of the nose hairs by means of a nose hair cutter according to embodiments of the present invention, in that the cutting edge does not protrude outwards beyond the guide groove, but rather extends within the guide groove.

Thus, embodiments of the present invention provide that the cutting edge is arranged in the guide groove in such a way that the skin of the nose does not penetrate into the guide groove, as far as the cutting edge, during cutting of the nose hairs.

As a result, the guide groove offers the advantage that, when a nose hair cutter according to embodiments of the present invention is used properly, a cutting contact between the cutting edge and the nasal skin is prevented. This reliably prevents cutting injuries.

The at least one guide groove provided according to embodiments of the present invention advantageously cause the nose hair to be supplied in the peripheral direction relative to the axis of rotation, during movement of cutting head, in particular a rotational movement of the cutting head, for nose hair cutting, in a bent state or a stress state of the blade. As a result, it is achieved according to embodiments of the present invention that the nose hair can be cut better or the cutting success is increased.

For better guidance of the nose hairs to the cutting blade, it is provided in a further advantageous development of embodiments of the present invention that the guide groove extends along the peripheral direction in such a way that its cross section decreases at least in portions, in particular continuously, in the peripheral direction relative to the axis of the main part, with increasing distance from the cutting edge. Within the context of embodiments of the present invention, it is provided, for example and in particular, that the edge is arranged in the region of the guide groove in which it has its largest cross section, and the cross section of the guide groove is reduced in portions with increasing distance from the cutting edge in the peripheral direction to the axis of the main part.

Embodiments of the present invention thus achieve the advantage that the nose hairs are aligned with respect to the cutting edge by a rotational movement of the cutting head about the axis of the main part, and are supplied to said cutting edge in a correspondingly aligned manner.

In order to avoid damage to the nose, embodiments of the present invention also comprise, for example and in particular, a haptic marking arranged on the main part, which can be felt in particular by the nose or the nose opening edge thereof. Such a haptic marking can advantageously be realized by the guide groove or the or one of the guide grooves. Such a marking promotes simple handling of a nose hair cutter according to embodiments of the present invention. Furthermore, a haptic marking according to embodiments of the present invention can also be realized by separate shoulders or recesses on the cutting head.

A further improvement of a feed of the nose hair to the cutting edge can be achieved, within the context of embodiments of the present invention, for example and in particular, by an at least partially increased or high surface quality of the guide groove, in that the surface of the guide groove (guide groove surface), which is formed on the groove base and the groove sides, is designed to be as smooth as possible at least in portions, for example and in particular in accordance having an arithmetic mean Ra in accordance with the version of DIN EN ISO 4287 that is valid currently or in the calendar year 2020 of less than/equal to 0.1 μm.

In order to increase a safe use of a nose hair cutter for cutting nose hairs, it is provided in a further advantageous development of embodiments of the present invention that at least one second guide groove or a plurality of guide grooves is/are formed on the surface, which in each case extend(s) longitudinally in parallel with the first guide groove, at least in portions, and into which an edge forming the cutting edge projects at least in portions transversely to the peripheral direction of the axis of the main part. The advantage of a use according to embodiments of the present invention of two or further guide grooves is that the region in which the cutting edge is free to the outside and can be reached via the guide groove opening is reduced, without the cutting performance of a nose hair cutter according to embodiments of the present invention significantly decreasing. This is achieved according to embodiments of the present invention by virtue of the fact that, instead of a large cutting region for cutting the nose hair, multiple comparatively smaller cutting regions is formed by the guide grooves which are arranged next to one another.

For better support of a cutting movement of a nose hair cutter according to embodiments of the present invention, the blade is held on the cutting head in a non-movable manner, in particular in a non-rotatable manner. For this purpose, in a further development of embodiments of the present invention, a cavity is formed in the interior of the cutting head, into which cavity the blade projects at least in portions, in particular with the majority of the surface area of the blade, and is held by means of holding means, in particular in a form-fitting and/or force-fitting manner. A non-movable holding on the cutting head can be achieved by various holding means. In the simplest case, the blade can be held by latching means so that the first latching means are formed in the cavity and corresponding latching means are formed on the blade so that the blade is held or fixed on the cutting head when these latching means are locked together.

In order to increase the handling of a nose hair cutter according to embodiments of the present invention, a further advantageous development of embodiments of the present invention is characterized in that the cutting head is shaped so as to taper, in particular conically, preferably in the manner of a truncated cone, at least in portions, in the axial direction relative to the axis of the main part, in the direction of the first end of the main part. As a result of this shaping of the cutting head according to embodiments of the present invention, it is advantageously achieved that a nose hair cutter according to embodiments of the present invention also cuts nose hairs located deeper in the nasal cavity. A tapering or conical shape of the cutting head can also limit the insertion of a nose hair cutter according to embodiments of the present invention, in such a way that damage to the nasal mucosa is prevented. In this respect, embodiments of the present invention makes it possible to easily and safely shorten not only nose hairs at the nose opening but also in the nasal vestibule.

Furthermore, embodiments of the present invention also cover the situation that at least the cutting head is shaped symmetrically with respect to a plane, in particular to the first main part plane, as a result of which, in turn, handling advantages result during use during cutting of nose hairs.

In order to promote simple and cost-effective production of a nose hair cutter according to embodiments of the present invention, it is provided in a further advantageous development of embodiments of the present invention that the main part is formed from two identically shaped main part components. In addition to the manufacturing, the storage for components of a nose hair cutter according to embodiments of the present invention is thus also promoted.

In order to further improve the cutting performance of a nose hair cutter, it is determined, in a further advantageous development of embodiments of the present invention, that the cutting head has at least two blades which are arranged offset to one another in the peripheral direction relative to the axis of the main part, in particular at an angle of 180°.

In this case, embodiments of the present invention take into account, for example and in particular, that two similar or identical blades are used, as a result of which the cutting success is increased, also cost-effectively.

Embodiments of the present invention also take into account that, when two or more blades are used, these are, for example and in particular, spaced apart from one another and are preferably arranged on the cutting head in a contact-free manner, as a result of which the assembly thereof on the cutting head is facilitated

Furthermore, embodiments of the present invention also provide, for example and in particular, that the blades are arranged on the cutting head such that the cutting edge of the respective blade extends longitudinally in the same main part plane. This in turn promotes a compact design of the cutting head.

By means of a use according to embodiments of the present invention of identically designed or identical parts, the production costs are reduced and the storage of the components of a nose hair cutter according to embodiments of the present invention is promoted.

The main part of a nose hair cutter according to embodiments of the present invention can be produced from different materials. It is possible, for example, to produce the nose hair cutter from a plastics material. In this case, it is also possible within the scope of embodiments of the present invention to use various plastics materials or types of plastics materials. Thus, different portions of the main part can be formed by different plastics materials so that the plastics material used in each case supports the relevant function fulfillment as optimally as possible. The use of plastics materials enables the realization of a low weight, good corrosion behavior or good resistance to water and cleaning agents, and good recycling.

With regard to better recycling, the use of a uniform material, in particular plastics material, for the formation of the main part is likewise provided within the scope of embodiments of the present invention.

Furthermore, it is possible to use renewable raw materials for the formation of a nose hair cutter according to embodiments of the present invention. In this case, wood or bamboo materials, which have the advantage of having a high ecological value, are found to be very suitable.

Moreover, it is also possible within the scope of embodiments of the present invention to combine different materials with one another in order to realize a nose hair cutter according to embodiments of the present invention.

Embodiments of the present invention are explained in more detail below with reference to the attached drawing, in which an example embodiment of a nose hair cutter according to embodiments of the present invention is shown as a representative of a plurality of nose hair cutters designed according to embodiments of the present invention.

In this case, all of the features that are claimed, described and illustrated in the drawing form the subject matter of embodiments of the present invention individually and independently of one another, and in any combination with one another, independently of their summarization in the claims and their dependency references, and also independently of their description or illustration in the drawing. The features are therefore not bound to the configuration explained below, but can also form a nose hair cutter according to embodiments of the present invention when isolated from each other as well as in a varying combination.

The figures in the drawing show a possible embodiment of a nose hair cutter according to embodiments of the present invention, in a schematic representation in each case. The illustrations in the figures are therefore in particular not necessarily to scale, so that the scales selected in each case in the figures may also differ from each other.

For greater clarity, the illustrations are concentrated on the elements/components/component parts supporting an understanding, the same or corresponding components/component parts or elements being provided with the same reference signs in the figures.

For a better overview, not always all elements/components/component parts are provided with reference signs in the figures, the assignment resulting from the same illustration or an illustration adapted to the view.

In the following, in the case of the same or a similar structure, for greater clarity the description is reduced to the differences between the figures.

The features illustrated on the basis of the figures also apply correspondingly or analogously, comprehensively as well as in a manner isolated from each other, to further nose hair cutters formed according to embodiments of the present invention. Embodiments of the present invention are therefore not limited to the embodiments or associations that are described and shown.

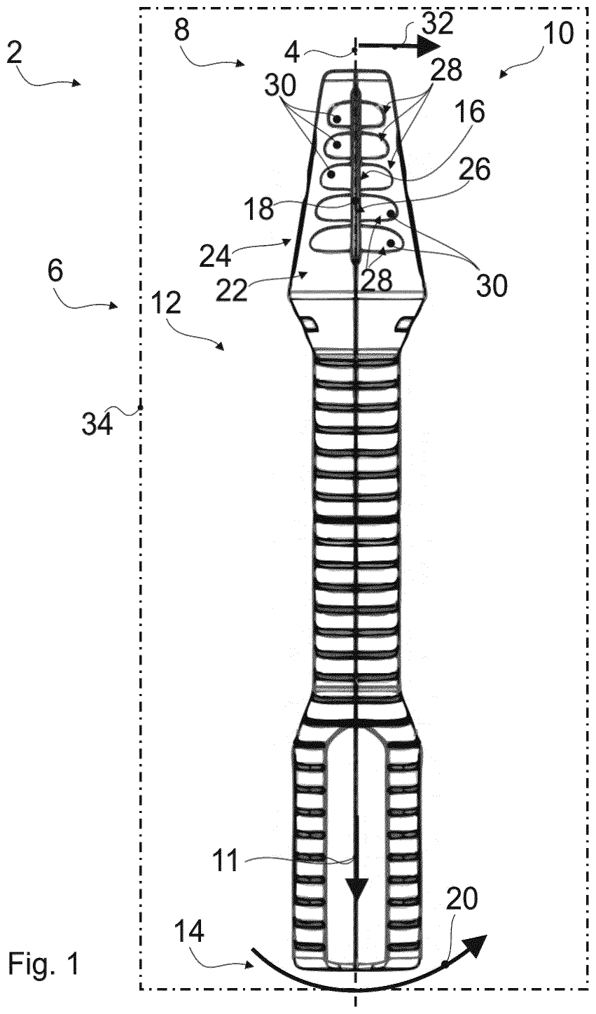

FIG. 1 shows a schematic side view of a nose hair cutter 2 according to an embodiments of the invention in a vertical orientation. Furthermore, the embodiment of a nose hair cutter 2 according to the invention is also referred to in shortened form as nose hair cutter 2.

The nose hair cutter 2 is used to cut nose hairs, use for cutting hair in ear holes also being possible.

The nose hair cutter 2 is equipped with a main part 6 which is formed along an axis 4 of the main part and has a cutting head 10 on a first end 8 of the main part and a handle 12 connected thereto which extends from the cutting head 10 in the direction of a second main part end 14 of the main part 6.

The cutting head 10 is shaped so as to taper in the axial direction 11 relative to the axis 4 of the main part at least in portions in the direction of the first end 8 of the main part, and in this embodiment is shaped in the manner of a truncated cone.

A blade 16 having a cutting edge 18 extending in the axial direction 11 relative to the axis 4 of the main part, for cutting the nose hairs, is arranged on the cutting head 10, for cutting the nose hairs. In addition to this blade 16, a further blade 16 is arranged on the cutting head 10, which is shown below and is not visible in FIG. 1 either, on account of the view selected there. However, embodiments of the present invention are not limited to the use of two blades, and therefore, for example, only one blade may also be used. Accordingly, a nose hair cutter 2 according to an embodiments of the present invention would be configured and designed accordingly.

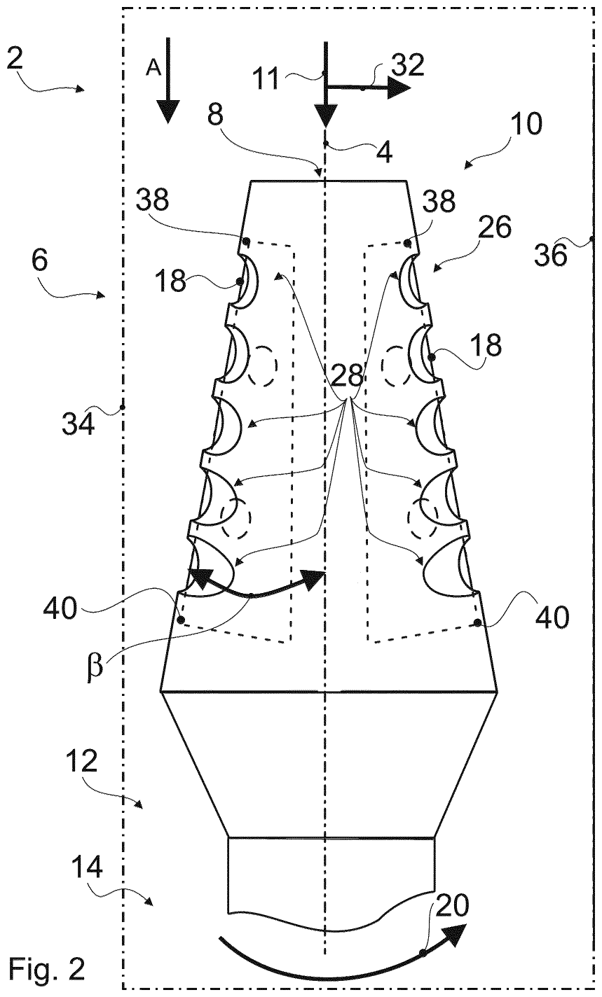

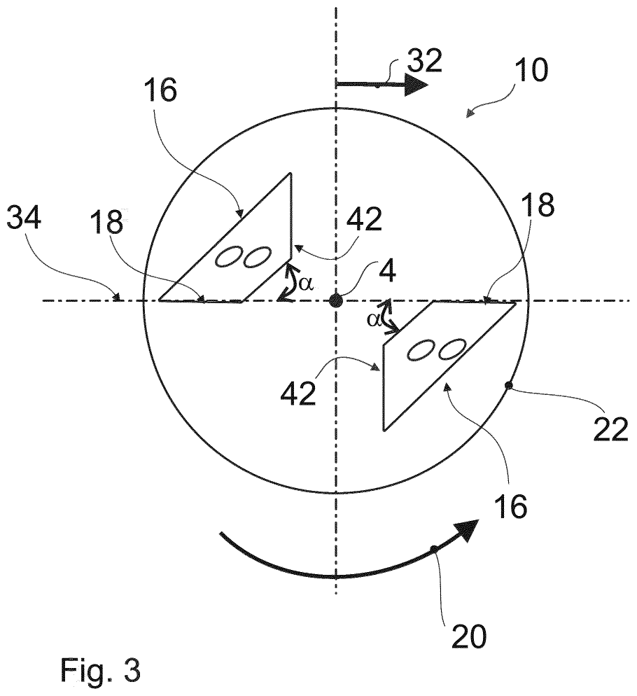

The cutting edge 18 is directed transversely to the drawing plane in FIG. 1, and the arrangement thereof is illustrated in FIG. 2 and/or FIG. 3 by means of a further view.

The blade 16 is arranged on the cutting head 10 in such a way that the cutting edge 18 of the visible blade 16 projects at least in portions from a surface 22 of the cutting head 10, which surface extends in a peripheral direction 20 to the axis 4 of the main part, in such a way that the cutting edge 18 intersects with the nose hairs supplied thereto on an exterior 24 of the cutting head 10. This arrangement is illustrated and explained further for both blades 16 with reference to FIG. 2.

On the surface 22 of the cutting head 10, a plurality of channel-shaped guide grooves 28 extending longitudinally in the peripheral direction 20 to the axis 4 of the main part (provided uniformly with reference sign 28) is formed for the nose hairs, into which the blade 16 projects at least in portions with an edge 26 that forms the cutting edge 18.

The guide grooves 28 extend in parallel with one another in the peripheral direction 20, the edge 26 forming the cutting edge 18 projecting into the respective guide groove 28 at least in portions, transversely to the peripheral direction 20 of the axis 4 of the main part.

The respective guide groove 28 extends along the peripheral direction 20 on the surface 22 of the cutting head 10 in such a way that its cross section, which extends transversely to the peripheral direction 20, continuously decreases with increasing distance in the peripheral direction from the cutting edge 18. The respective guide groove 28 extends on both sides of the blade edge in the peripheral direction to the axis of the main part so that the reduction of the cross section of the relevant guide groove in this embodiment also faces, accordingly on both sides, as a result of which the effect of the guide groove is independent of the direction of rotation.

The guide grooves 28 are configured identically, the cutting edge 18 of the blade 16 not protruding beyond the respective guide groove 28.

For better guidance of the nose hairs on the surface 22 of the cutting head 10, the respective guide groove 28 has, at least in portions, a guide groove surface 30 provided with a high surface quality, in particular in the manner of a finely smoothed, preferably polished, guide groove surface 30, which is part of the surface 22 of the cutting head 10. The guide groove surface 30 delimits the guide groove 28 in particular in the radial direction 32 and the axial direction 11 relative to the axis 4 of the main part. It is indicated uniformly for all guide grooves by reference sign 30.

FIG. 2 shows the nose hair cutter 2 in a schematic side view, in which the angle of inclination β is illustrated. The components of the nose hair cutter 2 are shown only once or a few times, in a representative manner, on account of a better overview. They apply similarly for the same components, which are assignable to one another due to the symmetrical representation to the axis 4 of the main part.

The cutting edge 18 extends in a first plane 34 of the main part extending in the radial direction 32 to the axis 4 of the main part. In other words, the plane 34 of the main part, as can be seen in FIG. 2, is spanned by the axis 4 of the main part and a parallel 36 spaced apart therefrom in the radial direction 26.

FIG. 2 illustrates that, due to the inclination of the blade 16 or its cutting edge 18 at an angle of inclination β to the axis 4 of the main part, a distance of the cutting edge 18, in the radial direction 32 relative to the axis 4 of the main part, from a second end 14 of the main part end in the direction of the first end 8 of the main part is reduced at least in portions.

In the nose hair cutter 2 shown, the cutting edge 18 extends in a straight line so that the radial distance from the axis 4 of the main part is continuous and, in this embodiment, decreases linearly.

In the nose hair cutter 2 shown, the angle of inclination β has a value of 10°.

Therefore, the spacing of the cutting edge 18 in the radial direction 32 with its cutting edge end 38 facing the first end 8 of the main part is smaller than with its cutting edge end 40 facing the second end 14 of the main part.

FIG. 3 illustrates that a flat 42 facing the axis 4 of the main part is positioned at least in portions at an acute angle of attack (α) relative to the first main part plane 34, as is symbolized in FIG. 3. In this embodiment, the angle of attack (α) is 45°, as a result of which an optimal cutting result can be achieved within the context.

As can be seen in FIG. 3, two identically designed blades 16 (provided uniformly with reference sign 16) are arranged on the cutting head 10 of the nose hair cutter 2, which blades are arranged offset to one another at an angle of 180° in the peripheral direction 20 to the axis 4 of the main part.

The blades 16 are spaced apart from one another and arranged on both sides of the axis 4 of the main part. In this embodiment, the blades 16 are arranged at a distance from one another in the radial direction 32 as well as in the peripheral direction 20 to the axis 4 of the main part. The blades 16 are arranged in a contact-free manner relative to one another.

As shown in FIG. 3, the blades 16 used are configured identically, at least geometrically.

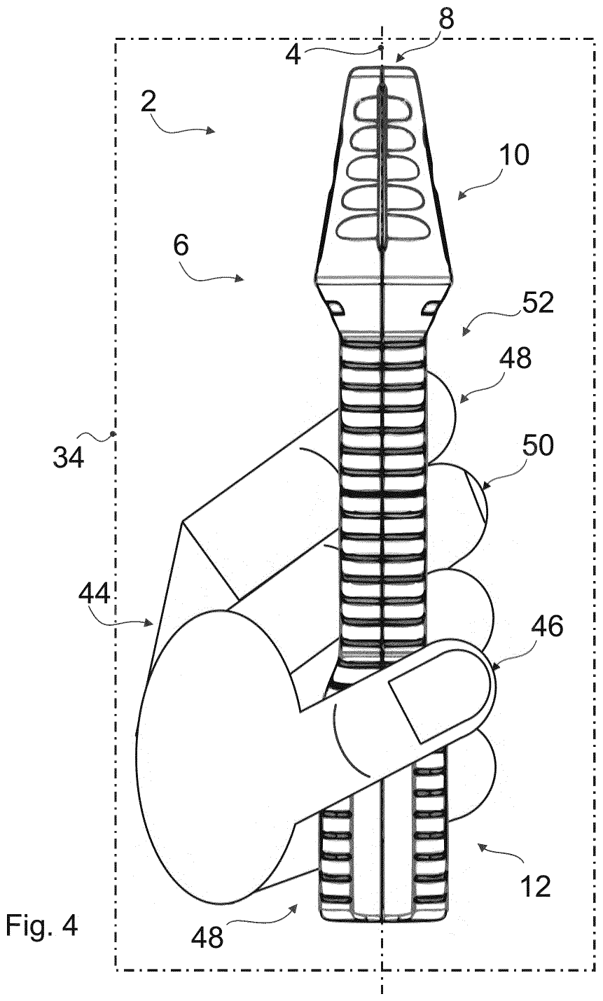

FIG. 4 shows the nose hair cutter 2 in a handling position in which it is held on the handle 12 by a human hand 44 symbolized in FIG. 4. In this case, in the handling position shown it is illustrated that the thumb 46 is arranged on one side of the handle 12 and an index or middle finger 48, 50 of the hand 44 is arranged on a side of the handle 12 opposite thereto. The cutting head 10 and the handle 12 are connected to one another for transmission of rotational movement or torque transmission therebetween.

By means of a rotational movement of the hand 44, the cutting head 10 is set into a rotational movement about the axis 4 of the main part, via the handle 12, with which the cutting head 10 is connected in a rotationally fixed manner. Thus, in a use position in a nose, a relative movement between the nose hair and the cutting head 10 takes place, in the course of which the nose hair comes into contact with the cutting edge 18 via the surface 22 of the main part 6 and is cut accordingly.

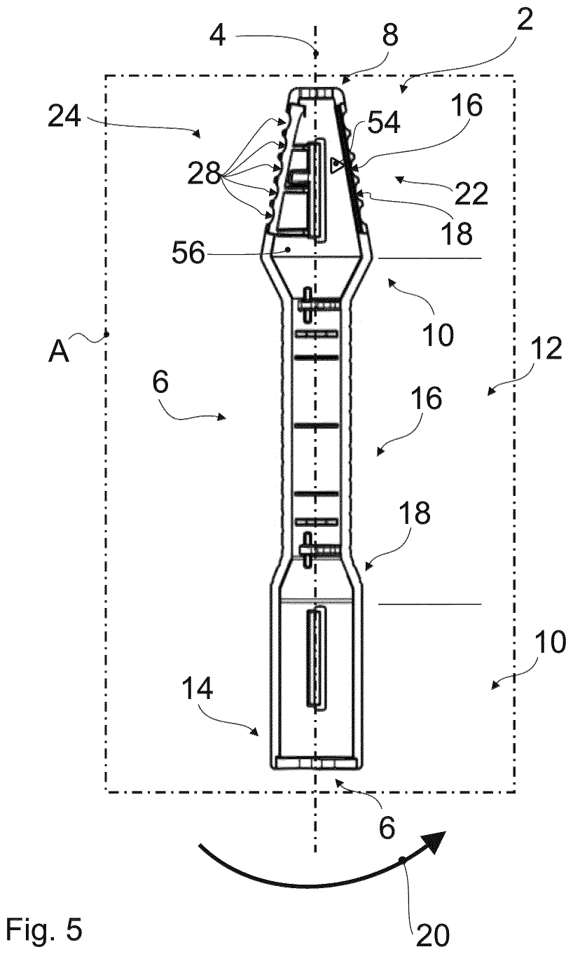

It can be seen in FIG. 5 that, in the case of the nose hair cutter 2, the blade 16 is held by means of holding means 54 (symbolized by a triangle in FIG. 5) on the cutting head 10, as a result of which the cutting head 10 and the blade 16 are connected to one another in a rotationally fixed manner.

The components of the nose hair cutter 2 are shown only once or a few times, in a representative manner, on account of a better overview. They apply similarly for the same components, which are assignable to one another due to the symmetrical representation to the axis 4 of the main part. In FIG. 5, only one blade 16 is shown symbolically and identified, in a representative manner.

For this purpose, a cavity 56 is formed inside the cutting head 10, into which the respective blade 16 projects at least in portions, in particular by a large part of the surface area of the respective blade 16 (as illustrated in FIG. 5 and also in FIG. 2) and is held in a form-fitting or force-fitting manner in the cavity 56 by the holding means 54.

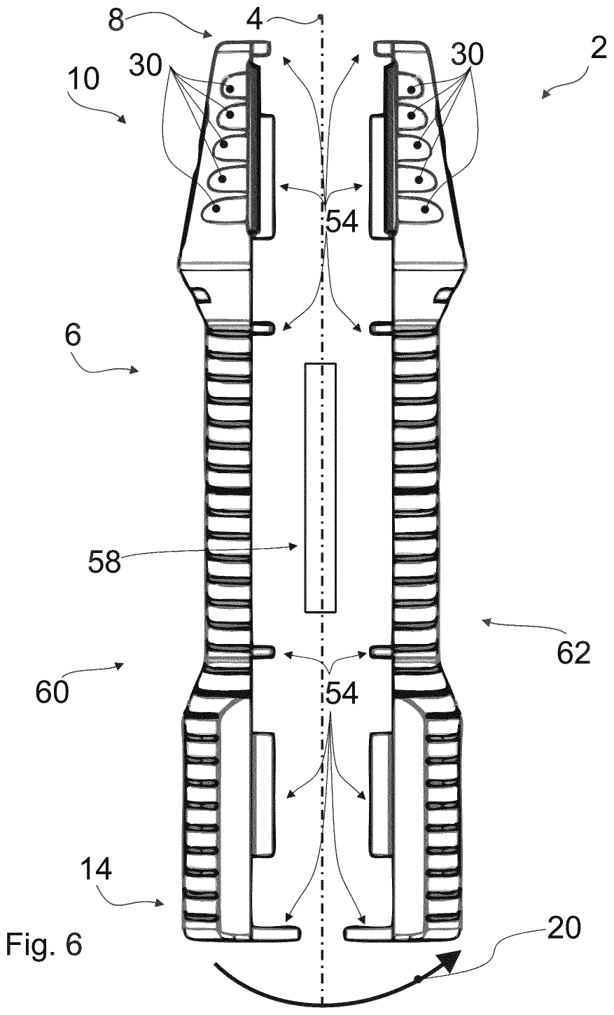

FIG. 6 shows that the cavity 54, for example, also extends into the handle 12 and can form a space for a tare body 58, which can be arranged therein as an additional weight for influencing the center of gravity of the nose hair cutter 2. In a simple embodiment, the tare body 58 can be formed by a cylindrical weight, for example made of a metal. This allows the handling of the nose hair cutter 2 to be positively influenced during cutting of the nose hair.

According to embodiments of the present invention, the main part 6 can be formed from different materials. In this case, it is also possible to use different materials in different portions. For example, the handle 12 can consist of bamboo, while the cutting head 10 is formed of a plastics material

In the embodiment shown, the main part 6 is made of a plastics material, the main part 6 being formed from two identically shaped main part components 60, 62, which, interconnected, form the main part 6. In FIG. 6, the main part components 60, 62 are shown radially spaced from the axis 4 of the main part, in that they are arranged in a pre-assembly state with respect to one another.

The main part components 60, 62 are connected by a combination of a form-fitting and force-fitting connection, a snap connection being used here for this purpose. In this embodiment, the main part components 60, 62 are arranged next to each other on the first plane 34 of the main part, in order to form the main part 6 in the connected state.

Therefore, in this embodiment, the main part 6 is designed symmetrically to the first plane 34 of the main part.

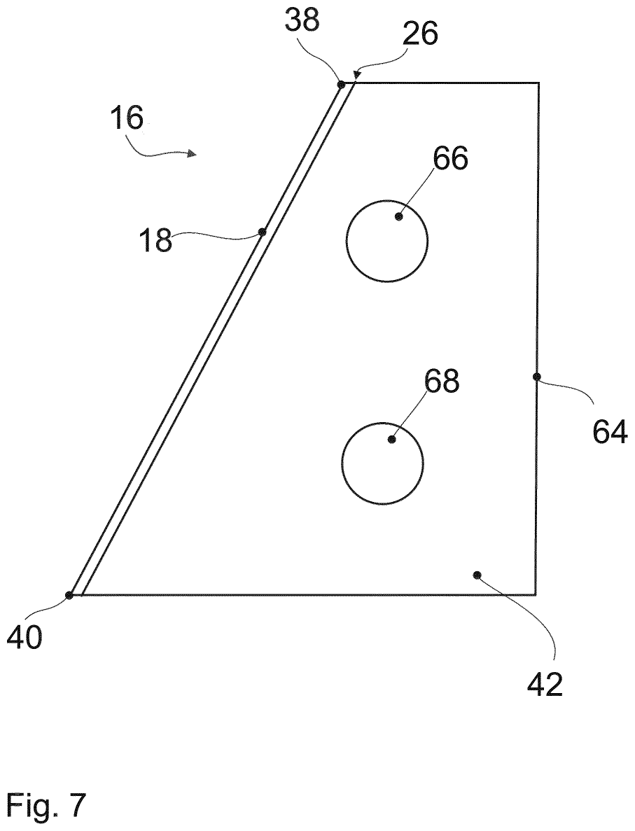

FIG. 7 shows one of the blades 16, which has a trapezoidal basic shape. On one side, the edge 26 is formed having the cutting edge 18, on the opposite side is the blade back 64, which has no edge 26. The flat 66 is formed between the blade back 64 and the edge 26. The flat 42 can also be referred to as a flank and, in itself, is the edge-free or unground part of the blade 16.

The blades 16 used each have an edge 16 having a two-sided blade polished surface, only one blade polished surface being discernible in the view selected in FIG. 7.

Two recesses 66, 68, which serve for arrangement of the respective blade 16 on the cutting head 10, are formed on the flat 42. In the mounted state of the blade 16 on the cutting head 10, pins, extending in each case from the cutting head 10 into the cavity 56, engage in the recesses 66, 68, as a result of which the respective blade 16 is held in a non-rotatable manner.

In addition to the pins, the holding means 54 also comprise a hold-down device, which presses the blade 16 against the cutting head 10, so that the blade 10 is held on the cutting head in a non-movable manner, in particular in a non-rotatable manner, when the pins and recesses 66, 68 interact.

Within the context of embodiments of the present invention, the aforementioned features can be designed within very wide limits and combined with one another. For a design according to an embodiment of the present invention of a nose hair cutter 2, the features described above, as described in the embodiment, can, however, also be used independently of the combination described in the embodiment and combined with one another.

Thus, the use of the features described in the embodiment is not a mandatory feature combination, and therefore individual or several features for forming a nose hair cutter 2 according to embodiments of the present invention are dispensable.

Therefore, embodiments of the present invention are not limited to the embodiment shown and the design explained on the basis thereof.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

| | |
|---|---|
| Nose hair cutter 2 | Hand 44 |
| Axis of the main part 4 | Thumb 46 |
| Main part 6 | Index finger 48 |
| First end of the main part 8 | Middle finger 50 |
| Cutting head 10 | Holding means 54 |
| Axial direction 11 | Cavity 56 |
| Handle 12 | Tare body 58 |
| Second end of the main part 14 | Main part component 60 |
| Blade 16 | Main part component 62 |
| Cutting edge 18 | Blade back 64 |
| Peripheral direction 20 | Recesses 66, 68 |
| Surface 22 | |
| Exterior 24 | Angle of attack α |
| Edge 26 | Angle of inclination β |
| (Trough-shaped) guide grooves 28 | |
| Guide groove surface 30 | |
| Radial direction 32 | |
| First plane of the main part 34 | |
| Parallel 36 | |
| Cutting edge end 38 | |
| Cutting edge end 40 | |
| Flat 42 | |

1. A nose hair cutter for cutting nose hairs, comprising
a main part formed along an axis thereof,
the main part comprising a cutting head and a handle connected thereto on a first end of the main part,
wherein a blade is arranged on the cutting head comprising a cutting edge extending in an axial direction to the axis of the main part for cutting the nose hairs,
wherein
the blade is arranged on the cutting head such that
the cutting edge of the blade protrudes at least in portions from a surface of the cutting head extending in a peripheral direction to the axis of the main part, such that the cutting edge intersects the nose hairs supplied to the cutting edge on an exterior of the cutting head,
wherein the cutting edge extends in a first plane of the main part extending in a radial direction to the axis of the main part,
and
wherein a flat facing the axis of the main part is positioned at least in portions at an acute angle of attack relative to the first plane of the main part.

2. The nose hair cutter according to claim 1, wherein the angle of attack has a value between 25° and 75°.

3. The nose hair cutter according to claim 1, wherein the cutting edge of the blade is inclined relative to the axis of the main part at an acute angle of inclination in a direction of the first main part end of the main part.

4. The nose hair cutter according to claim 3, wherein the angle of inclination has a value between 5° and 20°.

5. The nose hair cutter according to claim 1, wherein the cutting head and the handle are connected to one another for transmission of rotational movement between them.

6. The nose hair cutter according to claim 1, wherein at least one first trough-shaped guide groove for the nose hairs is formed on the surface of the cutting head at least in portions in the peripheral direction with respect to the axis of the main part, into which guide groove the blade projects at least in portions with an edge that forms the cutting edge.

7. The nose hair cutter according to claim 6, wherein the guide groove extends longitudinally along the peripheral direction such that the cross section of the guide groove decreases at least in portions, steadily, with increasing distance from the cutting edge in the peripheral direction to the axis of the main part.

8. The nose hair cutter according to claim 6, wherein at least one second guide groove or a plurality of guide grooves is/are formed on the surface, which in each case extend(s) longitudinally in parallel with the first guide groove, at least in portions, and into which the edge forming the cutting edge projects at least in portions transversely to the peripheral direction of the axis of the main part.

9. The nose hair cutter according to claim 1, wherein a cavity is formed in an interior of the cutting head, into which cavity the blade projects at least in portions with a main part of the surface area of the blade, and is held in the cavity in a form-fitting and/or force-fitting manner, by a holder.

10. The nose hair cutter according to claim 1, wherein the cutting head is shaped so as to taper conically in the axial direction relative to the axis of the main part, at least in portions, in the direction of the first end of the main part.

11. The nose hair cutter according to claim 1, wherein the main part is formed from two identically shaped main part components.

12. The nose hair cutter according to claim 1, wherein the cutting head has at least two blades which are arranged offset to one another in the peripheral direction to the axis of the main part at an angle of 180°.

13. The nose hair cutter according to claim 1, wherein the angle of attack has a value between 30° and 60°.

14. The nose hair cutter according to claim 1, wherein the angle of attack has a value between 44° and 46.

15. The nose hair cutter according to claim 1, wherein the angle of attack has a value of 45°.

16. The nose hair cutter according to claim 3, wherein the angle of inclination has a value of 10°.

17. The nose hair cutter according to claim 3, wherein the angle of inclination has a value between 5° and 15°.

18. The nose hair cutter according to claim 3, wherein the angle of inclination has a value between 8° and 12°.

19. The nose hair cutter according to claim 1, wherein the cutting head is shaped so as to taper conically, in the manner of a truncated cone, in the axial direction relative to the axis of the main part, at least in portions, in the direction of the first end of the main part.
